(19) United States
(12) Patent Application Publication
(10) Pub. No.: US 2018/0089809 A1
(43) Pub. Date: Mar. 29, 2018

(54) IMAGE DEBLURRING WITH A MULTIPLE SECTION, REGULARIZATION TERM

(71) Applicant: NIKON CORPORATION, Tokyo (JP)

(72) Inventor: Radka Tezaur, Belmont, CA (US)

(21) Appl. No.: 15/717,784

(22) Filed: Sep. 27, 2017

Related U.S. Application Data
(60) Provisional application No. 62/400,482, filed on Sep. 27, 2016.

(51) Int. Cl. G06T 5/00; G06T 7/00

(52) U.S. Cl. CPC G06T 5/003; G06T 7/0012; G06T 2207/30168; G06T 2207/20056; G06T 2207/30024; G06T 2207/20201; G06T 2207/10056

(57) ABSTRACT

A method for estimating a latent sharp image (15) for a blurry image (14) includes estimating the latent sharp image (15) with a control system (20) that utilizes a latent sharp image estimation cost function having a regularization term (538) that has a linear first section (540) and a linear second section (542) to characterize the pixels (14A) and adjust the pixels (14A) to create the latent sharp image (15) with the adjusted pixels (15A). The first section (540) has a first slope and the second section (542) has a second slope that is different from the first slope. Further, the first section (540) is connected to the second section (542) at a section knot (544).

### RELATED APPLICATION

This application claims priority on U.S. application Ser. No. 62/400482, filed on Sep. 27, 2016, and entitled “IMAGE DEBLURRING WITH A MULTIPLE SECTION, REGULARIZATION TERM”. As far as permitted, the contents of U.S. Application Ser. No. 62/400482 are incorporated herein by reference.

### BACKGROUND

Cameras are commonly used to capture an image of a scene that includes one or more objects. Unfortunately, the images can be blurred.

A blurred image is commonly modeled by a linear model described by the equation:

B=K*S+N. Equation (1)

In Equation (1) and elsewhere, (i) “B” represents the blurry image, (ii) “S” represents the latent sharp image, (iii) “K” represents the blur point spread function (PSF) kernel, and (iv) “N” represents noise (including quantization errors, compression artifacts, etc.).

The inverse problem (estimating the latent sharp image S for a given blurry image B) is called deconvolution and is difficult to solve. One common approach to estimating the latent sharp image S for a given blurry image B includes reformulating it as an optimization problem in which suitable cost functions are minimized. A common cost function can consist of (i) one or more fidelity terms, which make the minimum conform to equation (1) modeling of the blurring process, and (ii) one or more regularization terms, which make the solution more stable and help to enforce prior information about the solution, such as sparseness. Some of the most powerful and most commonly used deconvolution cost functions are derived using a maximum a posteriori (“MAP”) approach. For example, the MAP approach leads to the minimization of a latent sharp image estimation cost function that has the following form:

c(S)=Σₙ((K*S)ₙ−Bₙ)^{q}+ωΣₙΦ(Sₙ), Equation (2)

that sums over all the pixels in the image. In Equation (2), and elsewhere in this document, (i) c(S) is the Latent Sharp Image estimation cost function; (ii) the first term, Σₙ((K*S)ₙ−Bₙ)^{q} is a fidelity term that forces the solution to satisfy the blurring model in Equation (1) with a noise term that is small; (iii) the superscript “q” denotes the power for the fidelity term; (iv) the second term, ΣₙΦ(Sₙ) is a regularization term that helps to infuse prior information about arrays that can be a natural image; (v) “ω” is a regularization weight that depends on the parameters of the model describing the properties of the blur and the expected sharp image; (vi) “Φ” is a regularization function that depends on the prior model used to express the expected properties of the sharp image; and (vii) “Sₙ” is the sharp image pixel as position n.

When the noise is assumed to follow a Gaussian distribution, the power for the fidelity term(s) is equal to two (q=2). Thus, when the noise is assumed to be Gaussian, Equation (2) can be rewritten as the following latent sharp image cost function:

c(S)=Σₙ((K*S)ₙ−Bₙ)²+ωΣₙΦ(Sₙ). Equation (3)

An example of a common regularization term can be rewritten as follows:

Φ(Sₙ)=|∇Sₙ|^{p}. Equation (4)

In Equation (4) and elsewhere, (i) the superscript “p” denotes the regularization power (also referred to as “type of regularization prior”) for the regularization term(s); (ii) “∇” is a differential operator that represents the gradient; and (iii) “∇Sₙ” is the gradient of the sharp image pixel as position n.

When the image derivatives are assumed to follow a Gaussian probability distribution, the power p for the regularization term(s) is equal to two (p=2). This can be referred to as a “Gaussian regularization prior”. Equation (4) can be rewritten with a Gaussian regularization prior as follows:

$$Φ ( {S}_{n} ) = {\vert ∇ {S}_{n} \vert}^{2} = {( \frac{{dS}_{n}}{dx} )}^{2} + {( \frac{{dS}_{n}}{dy} )}^{2} . \qquad Equation ( 5 )$$

This is commonly referred to as Tikhonov-Miller regularization. In Equation 5 and elsewhere, dₓ and d_{y} are the partial derivatives in x and y direction.

A closed form formula exists for the location of the minimum of the latent sharp image estimation cost function of Equation (3) that uses Tikhonov-Miller regularization. More specifically, the closed form formula can be computed efficiently using the Fourier transform as follows:

$$S = {F}^{- 1} ( \frac{\overline{F ( K )} F ( B )}{\overline{F ( K )} F ( K ) + ω D} ) . \qquad Equation ( 6 )$$

In Equation (6) and elsewhere, (i) F denotes the Discrete Fourier Transform (DFT) operator, and (ii) “D” is a term having the following form:

D=F̅(Dₓ)+F(Dₓ)+F̅(̅D̅_̅{̅y̅}̅)̅F(D_{y}). Equation (7)

In Equation 7 and elsewhere, Dₓ and D_{y} are the convolution kernels that can be used to express the partial derivatives in x and y direction.

However, it should be noted that regularization priors other than two (p≠2) often provide better results, e.g. a sharper image with less noise. Unfortunately, with these other regularization priors, there no longer exists a closed form formula for the minimum of the cost function of Equation (3), and the cost function needs to be minimized by some iterative algorithm.

The other regularization priors that are popular include (i) having a regularization prior value of one (p=1), that results from assuming that the gradient magnitude follows a Laplacian distribution; or (ii) having a regularization prior value that is less than one (p<1) to promote the sparseness of the image gradient. The regularization term of Equation (4) can be rewritten for a Laplacian regularization prior (p=1) as follows:

$$Φ ( {S}_{n} ) = \vert ∇ {S}_{n} \vert = \sqrt{{( \frac{{dS}_{n}}{dx} )}^{2} + {( \frac{{dS}_{n}}{dy} )}^{2}} . \qquad Equation ( 8 )$$

This is commonly referred to as Total Variation (TV) regularization. When the regularization prior value is less than one (p<1), this is commonly referred to as a hyper-Laplacian regularization prior. Non-exclusive examples of hyper-Laplacian regularization priors include p=⅔and ½.

A latent sharp image estimation cost function (e.g. Equation (3)) that uses a Laplacian regularization prior (TV regularization) can be minimized very efficiently using a method often referred to as a “variable splitting technique”. Somewhat similarly, certain select hyper-Laplacian regularization priors (e.g. p=⅔, ½) can also be minimized very efficiently using the variable splitting method. A description of the variable splitting method used with hyper-Laplacian priors is provided in D. Krishnan, R. Fergus: Fast Image Deconvolution using Hyper-Laplacian Priors, NIPS 2009 (hereinafter “Krishnan”). As far as permitted, the contents of Krishnan are incorporated herein by reference.

Unfortunately, the use of the Laplacian regularization prior or certain select hyper-Laplacian regularization prior values do not fit very well in the gradient distribution of all types of images.

Further, latent sharp image estimation cost functions that use other hyper-Laplacian regularization priors (e.g. p≠⅔, ½) do not lead to an auxiliary variable minimization equation that can be solved efficiently using some closed form formulas. For these other values, a numerical solution of a non-linear equation would be required. As a result thereof, complicated minimization algorithms are necessary to minimize these cost functions.

Moreover, the existing latent sharp image estimation cost functions cannot be easily adjusted for many different types of images. For example, the existing latent sharp image estimation cost functions can be adjusted by changing the regularization prior value. However, this will lead to a completely different minimization process or significant changes to the minimization process. Thus, every time it is desired to change the regularization prior value, a completely different minimization processes must developed.

### SUMMARY

The present invention is directed to a method for estimating a latent sharp image for at least a portion of a blurry image that includes a plurality of pixels. The method includes estimating the latent sharp image with a control system that includes a processor. In one embodiment, the control system utilizes a latent sharp image estimation cost function having a regularization term that has a linear first section and a linear second section to characterize the plurality of pixels and adjust at least some of the pixels to provide the estimated latent sharp image. With this design the pixels of the blurry image are evaluated and adjusted on a pixel-by-pixel basis to generate the latent sharp image. As provided herein, the first section has a first slope and the second section has a second slope that is different from the first slope. Further, the first section is connected to the second section at a section knot. The multiple section, regularization term provided herein can alternatively be referred to as a “Laplacian mixture regularization prior”, “multiple section prior distribution”, “multiple section, regularization function”, or a “piece-wise linear regularization prior”.

In this embodiment, (i) the first slope, (ii) the second slope, and (iii) the location of the section knot are regularization parameters of the regularization term. As provided herein, one or more of the regularization parameters can be adjusted to change the latent sharp image estimation cost function to best suit the characteristics of the blurry image. As a result thereof, the resulting latent sharp image is more accurate.

Further, as provided in more detail below, the latent sharp image estimation cost function provided herein can be minimized efficiently summing over all of the pixels in the blurry image with the control system utilizing a variable splitting technique. Moreover, the same minimization process can be used even when the regularization parameters are adjusted. As a result thereof, the latent sharp image estimation cost function can be adjusted and minimized relatively easily and rapidly.

In one embodiment, the latent sharp image estimation cost function includes the following regularization term: ΣₙΦ(Sₙ) , where (i) “Φ” is a regularization function that depends on the prior model used to express the expected properties of the sharp image; (ii) “Sₙ” is the sharp image pixel as position n; (iii) Φ(Sₙ)=λ₁|∇Sₙ| if |∇Sₙ|≦T; (iv) Φ(Sₙ)=λ₂|∇Sₙ|+(λ₁−λ₂)T if |∇Sₙ|≧T; (v) “λ₁” is the slope of the first section; (vi) “λ₂” is the slope of the second section; and (vii) “T” is the location of the section knot.

In another embodiment, the latent sharp image estimation cost function can have the following form: c(S)=Σₙ((K*S)ₙ−Bₙ)^{q}+ωΣₙΦ(Sₙ), where (i) c(S) is the latent sharp image cost function; (ii) K is the point spread function kernel; (iii) S is the latent sharp image; (iv) B is the blurry image; (v) n is the position of the pixel; (vi) q is a fidelity power; (vii) ω is a regularization term weight; (viii) “Φ” is a regularization function that depends on the prior model used to express the expected properties of the sharp image; (ix) “Sₙ” is the sharp image pixel as position n; (x) Φ(Sₙ)=λ₁|∇Sₙ| if |∇Sₙ|≦T; (xi) Φ(Sₙ)=λ₂|∇Sₙ|+(λ₁−λ₂)T if |∇Sₙ|≧T; (xi) “λ1” is the slope of the first section; (xii) “λ₂” is the slope of the second section; and (xiii) “T” is the location of the section knot.

Additionally, the regularization term can also include a linear third section having a third slope that is different from the first slope and the second slope. In this embodiment, the first section is connected to the second section at a first section knot, and the second section is connected to the third section at a second section knot.

In yet another embodiment, the present invention is directed to a system for estimating a latent sharp image for at least a portion of a blurry image that includes a plurality of pixels. The system can include a control system that estimates the latent sharp image utilizing a latent sharp image estimation cost function having a regularization term that has a linear first section and a linear second section to characterize the plurality of pixels and adjust at least some of the pixels to provide the estimated latent sharp image.

The present invention also directed to a method and device for estimating a point spread function for at least a portion of a blurry image that includes a plurality of pixels. The method includes estimating the point spread function with a control system that includes a processor. In one embodiment, the control system utilizes a point spread function estimation cost function having a regularization term that has a linear first section and a linear second section to characterize the plurality of pixels and adjust at least some of the pixels to provide the estimated latent sharp image. As provided herein, the first section has a first slope and the second section has a second slope that is different from the first slope. Further, the first section is connected to the second section at a section knot. The multiple section, regularization term provided herein can alternatively be referred to as a “Laplacian mixture regularization prior”, “multiple section prior distribution”, “multiple section, regularization function”, or a “piece-wise linear regularization prior”.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified side illustration of an image apparatus, and a computer having features of the present invention;

FIG. 2A is an illustration of a widefield microscope image;

FIG. 2B is an illustration of a confocal microscope image;

FIG. 3A is an illustration of a three dimensional widefield microscope image;

FIG. 3B is an illustration of a three dimensional confocal microscope image;

FIG. 4 is a graph that illustrates log likelihood of gradient magnitude values for the confocal microscope image of FIG. 2B, and two different regularization prior values;

FIG. 5 is a graph that illustrates log likelihood of gradient magnitude values for the confocal microscope image of FIG. 2B, and an embodiment of a multiple section, regularization term;

FIG. 6 is a graph that illustrates log likelihood of gradient magnitude values for three alternative multiple section, regularization terms; and

FIG. 7 is a graph that illustrates log likelihood of gradient magnitude values for another image, and yet another embodiment of a multiple section, regularization term.

### DESCRIPTION

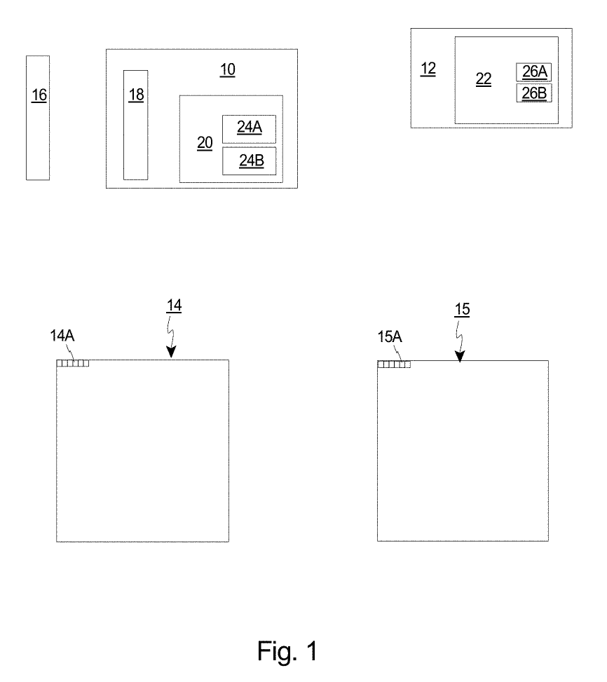

FIG. 1 is a simplified side illustration of an image apparatus 10 (illustrated as a box) and a computer 12. As provided herein, the image apparatus 10 is used to capture a captured image 14 (illustrated as a box) of one or more objects 16 (illustrated as a box). The captured image 14 includes a plurality of pixels 14A (a few are illustrated as small squares for reference). As non-exclusive examples, the captured image 14 can include hundreds, thousands or millions of pixels 14A.

In certain embodiments, the present invention is directed to one or more unique algorithms and methods that are used by the image apparatus 10 and/or the computer 12 to accurately deblur the captured, blurred image 14 to provide a deblurred, latent sharp image 15 (illustrated as a box). The latent sharp image 15 includes a plurality of pixels 15A (a few are illustrated as small squares for reference). As non-exclusive examples, the latent sharp image 15 can include hundreds, thousands or millions of pixels 15A.

More specifically, in certain embodiments, the present invention uses a latent sharp image estimation cost function having a multiple section, regularization prior distribution to deblur the blurred image 14. Further, the multiple section, regularization power can be easily adjusted to better match (correspond) the characteristics of the desired latent sharp image 15 or the blurred image 14. Stated in another fashion, the latent sharp image estimation cost function provided herein can be easily adapted to different types of blurred images 14, with different levels of sparseness, by merely adjusting one or more regularization parameters of the regularization term, instead of using a completely different regularization power that leads to a different minimization process. Because, the latent sharp image estimation cost function can be specifically tailored to different types of blurred images 14, the resulting latent sharp image 15 is more accurate. It should be further appreciated that the system and method described herein enables improvement in the functionality of the image apparatus 10 and/or the computer 12 due to the ability of the latent sharp image estimation cost function (with a multiple section, regularization prior distribution) to deblur the blurred image 14 in an improved fashion both in speed and quality of the resulting latent sharp image 15. Further, images 14 captured rapidly with the image apparatus 10 can quickly and accurately be deblurred with the latent sharp image estimation cost function provided herein to improve the quality of the images 14. The latent sharp image estimation cost function is used to characterize the plurality of pixels 14A from the blurred image 14 and adjust at least some of the pixels 14A of the blurred image 14 to provide the adjusted pixels 15A of the estimated latent sharp image 15. In certain embodiments, all of the pixels 14A of the blurred image 14 are evaluated and adjusted to provide the improved pixels 15A of the latent sharp image 15. Stated in another fashion, with the present design the pixels 14A of the blurry image 14 are all evaluated and adjusted on a pixel-by-pixel basis to generate the pixels 15A of the latent sharp image 15.

Moreover, this latent sharp image estimation cost function can be minimized easily and efficiently, in a MAP image deblurring method, using a variable splitting algorithm. This improves the efficiency of the apparatus performing the deblurring. Further, the same minimization process can be used regardless of the adjustments made to the regularization parameters. This allows for the same cost function to be used and tailored for many different deblurring applications.

As non-exclusive examples, the image apparatus 10 can be (i) a digital camera and the algorithm can be used to remove blur (e.g. motion or optics) from the captured image 14, or (ii) a microscope, such as a widefield microscope, and the algorithm can be used for deconvolution of a widefield microscope image 14. Thus, the invention is applicable to deblurring (deconvolution) of different types of images, including regular photographs, microscope images, and other types of images. Stated in another fashion, the deconvolution algorithm can be used for blur removal in digital images 14 from a camera, or in software used for processing captured images 14, or for deconvolution of three dimensional widefield microscope images.

In certain embodiments, the image apparatus 10 can include an image sensor 18 (e.g. a semiconductor device that records light electronically) that captures the information used for the captured image 14. The image sensor 18 receives the light and converts the light into electricity. One non-exclusive example of an image sensor 18 for digital cameras is known as a charge coupled device (“CCD”). An alternative image sensor 18 that may be employed in digital cameras uses complementary metal oxide semiconductor (“CMOS”) technology. However, other sensors can be utilized.

Additionally, the image apparatus 10 can include an imager control system 20 that uses one or more of the algorithms for deconvoluting the image 14. Similarly, the computer 12 can include a computer control system 22 that uses one or more of the algorithms for deconvoluting the image 14.

The imager control system 20 can include one or more processors 24A (illustrated as a box) and circuits that perform the methods and formulas provided herein, and an imager digital storage system 24B (illustrated as a box) that stores the related data. Similarly, the computer control system 22 can include one or more processors 26A (illustrated as a box) and circuits that perform the methods and formulas provided herein, and a computer digital storage system 26B that stores the related data.

The type of object 16 captured by the image apparatus 10 can vary. For example, the object 16 can be a scene that is captured by a digital camera. Alternatively, for example, the object 16 can be a sample that is being analyzed by a widefield microscope. For example, the sample can be a Drosophilla S2 cell, or another type of sample.

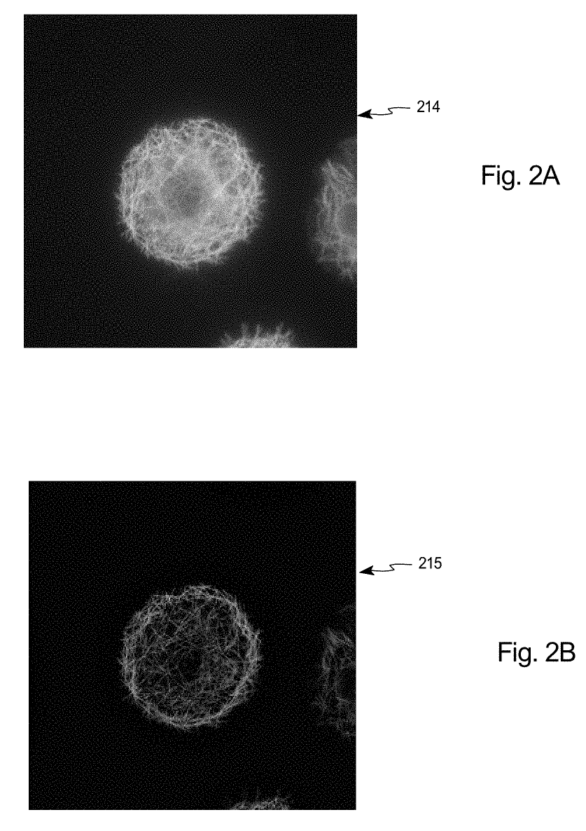

FIG. 2A is an illustration of a widefield microscope image 214 of a Drosophilla S2 cell captured with a widefield microscope (not shown in FIG. 2A). Further, FIG. 2B is an illustration of a confocal microscope image 215 of the Drosophilla S2 cell captured with a confocal microscope (not shown in FIG. 2B). Generally, the widefield microscope image 214 can be captured much faster than the confocal microscope image 215 because the confocal microscope requires a much longer exposure time. However, the confocal microscope image 215 is much sharper than the widefield microscope image 214. Thus, in one embodiment, the confocal microscope image 215 can be used as a model of a sharp image that we are trying to obtain by deconvoluting widefield microscope image 214. Stated in another fashion, the algorithm provided herein can be adjusted and tailored to deconvolute the widefield microscope image 214 based on properties of the confocal microscope image 215. As a result thereof, the resulting deblurred image (not shown in FIGS. 2A and 2B) from the widefield microscope image 214 will be more accurate.

It should be noted that the confocal microscope image 215 in FIG. 2B has (i) a sparse distribution of pixel values because a large number of pixels are black, with a few white pixels; and (ii) a sparse number of gradients because there are relatively few edges in the image 215. As provided herein, in certain embodiments, one or more of the regularization parameters of the multiple section, regularization term can be adjusted in view of these characteristics of the confocal microscope image 215 to more accurately deblur the widefield microscope image 214 of FIG. 2A.

Further, as provided herein, the present algorithm can be adjusted and tailored to accurately deconvolute a blurred image, even if a model of the sharp image does not exist. Stated in another fashion, one or more of the regularization parameters of the multiple section, regularization term can be adjusted to more accurately deconvolute a blurred image. It should be noted that, as a non-exclusive example, the deconvolution algorithm provided herein can be used to deblur a widefield microscope image 214 so that it approaches the quality of a confocal microscope image 215.

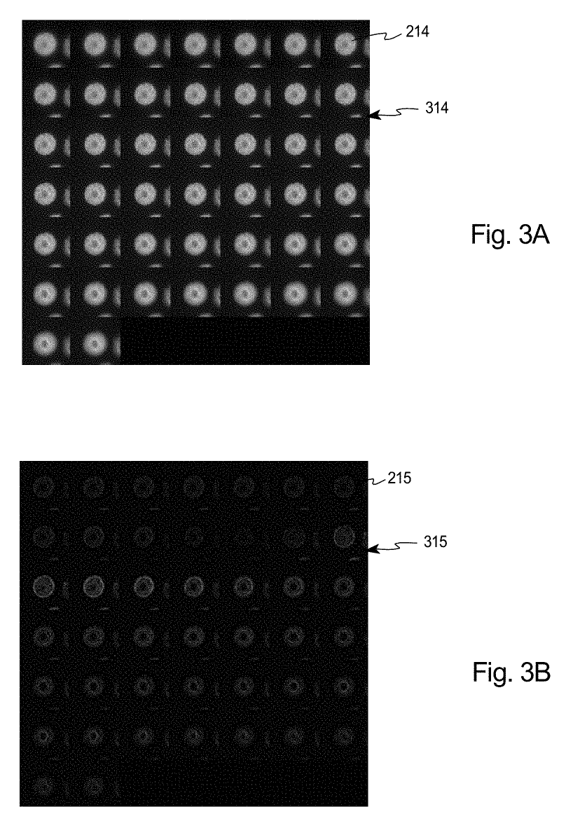

FIG. 3A is an illustration of a three dimensional widefield microscope image 314 of the Drosophilla S2 cell captured with the widefield microscope (not shown in FIG. 3A). For example, the widefield microscope can be used to sequentially capture a plurality of widefield microscope images 214 of the Drosophilla S2 cell, with each image 214 being captured at a different depth level. Subsequently, the widefield microscope images 214 can be combined to generate the three dimensional, widefield microscope image 314.

The number of widefield microscope images 214 used to generate the three dimensional, widefield microscope image 314 can be varied. In the non-exclusive example illustrated in FIG. 3A, the three dimensional, widefield microscope image 314 includes forty-four widefield microscope images 214.

Similarly, FIG. 3B is an illustration of a three dimensional confocal microscope image 315 of the Drosophilla S2 cell captured with the confocal microscope (not shown in FIG. 3B). For example, the confocal microscope can be used to sequentially capture a plurality of confocal microscope images 215 of the Drosophilla S2 cell, with each image 215 being captured at a different depth level. Subsequently, the confocal microscope images 215 can be combined to generate the three dimensional, confocal microscope image 315.

The number of confocal microscope images 215 used to generate the three dimensional, confocal microscope image 315 can be varied. In the non-exclusive example illustrated in FIG. 3B, the three dimensional, confocal microscope image 315 includes forty-four confocal microscope images 314.

Generally, the three dimensional widefield microscope image 314 can be generated much faster than the three dimensional confocal microscope image 315 because of the longer exposure time required by the confocal microscope. However, the three dimensional confocal microscope image 315 is much sharper than the three dimensional confocal widefield microscope image 314.

As provided herein, the three dimensional confocal microscope image 315 can be used as a model of a sharp image that we are trying to obtain by deconvoluting the three dimensional widefield microscope image 314. Thus, the present algorithm provided herein is adjusted and tailored to deconvolute the three dimensional widefield microscope image 314 based on properties of the three dimensional confocal microscope image 315. As a result thereof, the resulting deblurred image (not shown) from the three dimensional widefield microscope image 314 will be more accurate.

It should be noted that the three dimensional confocal microscope image 315 of FIG. 3B has (i) a sparse distribution of pixel values because a large number of pixels are black, with a few white pixels; and (ii) a sparse number of gradients because there are relatively few edges in the image 315. As provided herein, in certain embodiments, one or more of the regularization parameters of the multiple section, regularization term can be adjusted in view of these characteristics of the three dimensional confocal microscope image 315 to more accurately deblur the three dimensional widefield microscope image 314 of FIG. 3A.

Further, as provided herein, the present algorithm can be adjusted and tailored to accurately deconvolute a blurred, three dimensional image, even if a model of the three dimensional sharp image does not exist. Stated in another fashion, one or more of the regularization parameters of the multiple section, regularization term can be adjusted to more accurately deconvolute the three dimensional blurred image.

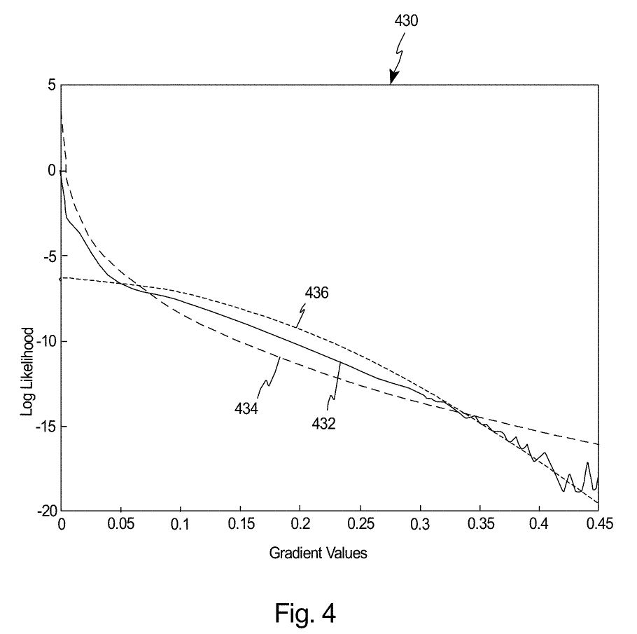

FIG. 4 is a graph 430 that illustrates log likelihood of gradient magnitude values for the confocal microscope image 215 of the Drosophilla S2 cell of FIG. 2B. More specifically, solid line 432 represents the gradient magnitude log likelihood distribution for the confocal microscope image 215 of the Drosophilla S2 cell. Further, (i) long-dashed line 434 in FIG. 4 represents the gradient magnitude log likelihood distribution for a Hyper-Laplacian regularization term (p=⅓); and (ii) short-dashed line 436 in FIG. 4 represents the gradient magnitude log likelihood distribution for the model used and disclosed by B. Dong, L. Shao, A. F. Frangi, O. Bandmann, M. Da Costa: Three-Dimensional Deconvolution of Wide Field Microscopy with Sparse Priors: Application of Zebrafish Imagery, ICPR, 2014.

Neither, the long-dashed line 434 or the short dashed line 436 fits well for both the small and large gradient magnitude values of line 432. As a result thereof, if either of these regularization priors are used to deconvolute the widefield microscope image 214 (illustrated in FIG. 2A) or the three dimensional widefield microscope image 314 (illustrated in FIG. 3A), the resulting latent sharp image (not shown in FIG. 4) will not be as accurate.

As provided above, the present invention utilizes a multiple section, regularization term instead of a Laplacian or hyper-Laplacian regularization prior. As a result thereof, the log likelihood model can have the form of a piece-wise linear function that can be adjusted to closely fit both the small gradient and large gradient portions of the log likelihood distribution of the desired latent sharp image.

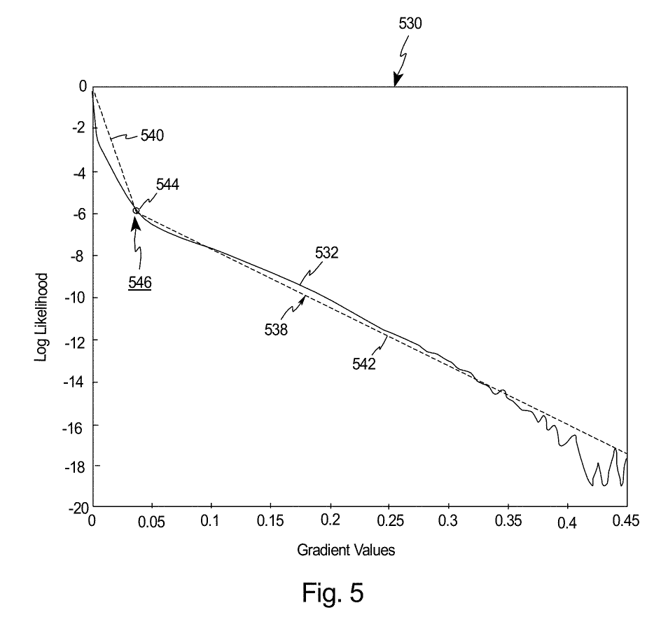

FIG. 5 is a graph 530 that illustrates log likelihood of gradient magnitude values for the confocal microscope image 215 of the Drosophilla S2 cell of FIG. 2B. More specifically, solid line 532 represents the gradient magnitude log likelihood distribution for the confocal microscope image 215 of the Drosophilla S2 cell. Further, the dashed line 538 in FIG. 5 represents the gradient magnitude log likelihood distribution for one embodiment of the multiple section, regularization term provided herein. Importantly, the multiple section, regularization term (represent by line 538) can be adjusted and tailed to closely correspond to the gradient magnitude values 532 of the confocal microscope image 215. As a result thereof, the multiple section, regularization term 538 can be used in the latent sharp image estimation cost function to accurately deconvolute the widefield microscope image 214 (illustrated in FIG. 2A) or the three dimensional widefield microscope image 314 (illustrated in FIG. 3A). Stated in another fashion, the characteristics of the sparse confocal microscope image 215 can be modeled by the piece-wise linear prior.

As provided herein, the multiple section, regularization term 538 can include two or more linear sections that are connected together. In FIG. 5, the multiple section, regularization term 538 includes (i) a linear first section 540 having a first slope, (ii) a linear second section 542 having a second slope that is different from the first slope, and (iii) a section knot 544 (highlighted with a circle) that joints the first section 540 to the second section 542 to form a continuous multiple section, regularization term (or “function”) 538. Alternatively, the multiple section, regularization term 538 can be designed to include more than two linear sections, which will result in at least two section knots.

As provided herein, the number of linear section(s), the slope of each linear section, and the location of each section knot can be collectively referred to as “regularization parameters” 546 of the regularization term 538. For example, in FIG. 5, (i) the first slope of the first section 540; (ii) the second slope of the second section 542; and (v) the location of the section knot 544 are the regularization parameters 546 of the regularization term 538. As provided herein, one or more of the regularization parameters 546 can be adjusted to change regularization term 538 and the latent sharp image estimation cost function to best suit the characteristics of the blurry image. As a result thereof, the resulting latent sharp image is more accurate.

As illustrated in FIG. 5, the multiple section, regularization term 538 with two linear sections 540, 542 can provide a very accurate fit for the gradient magnitude values 532 for the confocal microscope image 215 of the Drosophila S2 cell. Stated in another fashion, the regularization parameters 546 can be adjusted so that the regularization term 538 closely matches the gradient magnitude values 532 of the confocal microscope image 215.

Alternatively, the multiple section, regularization term 538 can be easily adapted for different types of images with different levels of sparseness, by adjusting the regularization parameters 546 of the multiple section, regularization term 538. More specifically, the multiple section, regularization term 538 can be easily adjusted by adjusting the number of sections, the slope of each of the sections, and/or the location of the one or more section knots. Thus, these regularization parameters 546 can be adjusted as needed to improve the deconvolution of the blurry image.

In the example of the widefield microscope image 214 provided herein, an approximation of the latent sharp image is provided by the confocal microscope image 215. As a result thereof, the regularization parameters 546 of the multiple section, regularization term 538 can be adjusted to correspond to that of the confocal microscope image 215.

Alternatively, in practice, the exact characteristics of the latent sharp image are not exactly known. In these cases, a trial and error process can be performed where multiple deblurrings of the blurry image are performed while adjusting one or more of the regularization parameters 546 of the multiple section, regularization term 538. This process can be repeated until a good latent sharp image is achieved. This trial and error process can be performed by one of the control systems 20, 22 illustrated in FIG. 1. Also, it does not necessarily have to be trial and error process, but some optimization algorithm (e.g. maximizing some criteria like a sharpness measure). This optimization algorithm can also be performed by one of the control systems 20, 22.

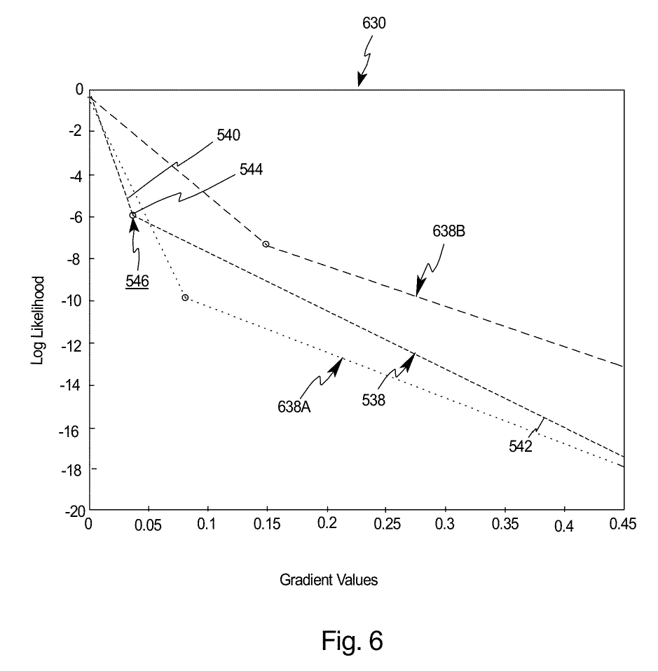

FIG. 6 is a graph 630 that illustrates log likelihood of gradient magnitude values and includes (i) short dashed line 538 that represents the multiple section, regularization prior distribution (“term”) from FIG. 5; (ii) dotted line 638A that represents another multiple section, regularization prior distribution; and (iii) long dashed line 638B that represents still another multiple section, regularization prior distribution.

In this embodiment, each line 538, 638A, 638B includes the first section 540, the second section 542, and the section knot 544. FIG. 6 illustrates how the regularization parameters 546 can be adjusted to change the multiple section, regularization term and the characteristics of the latent sharp image estimation cost function.

In one embodiment, the regularization term can involve the multiple section, regularization function having the following form:

$$\begin{matrix}Φ ( {S}_{n} ) = {λ}_{1} \vert ∇ {S}_{n} \vert if \vert ∇ {S}_{n} \vert \leq T , \\ = {λ}_{2} \vert ∇ {S}_{n} \vert + ( {λ}_{1} - {λ}_{2} ) T if \vert ∇ {S}_{n} \vert \leq T .\end{matrix} \\ where {λ}_{1} \geq {λ}_{2} \geq 0 and T > 0. \qquad Equation ( 9 )$$

In Equation (9) and elsewhere, (i) lamda one (“λ₁”) is the slope of the first section 540; (ii) lamda two (“λ₂”) is the slope of the second section 542; and (iii) “T” is the location of the section knot 544 and is greater than zero. The section knot 544 can also be referred to as a joint that joints the sections 540, 542. With this design, (i) if the gradient magnitude is less than or equal to T, the first slope is utilized; and (ii) if the gradient magnitude is greater than T, the first second is utilized. Further, in Equation (9), the term “(λ₁−λ₂) T” is an offset that makes the regularization function continuous.

In the example illustrated in FIG. 5, the slope of the first section 540 is greater than the slope of the second section 542, and the section knot 544 is approximately equal to 0.035. Alternatively, the regularization function 538 can be designed so that the slope of the first section 540 is less than the slope of the second section 542, and/or the section knot can have a different value than illustrated in FIG. 5.

The regularization function of Equation (9) can be implemented into Equation (2) to provided the following, single latent sharp image cost function for the deconvolution of widefield images:

$$c ( S ) = {\sum }_{n} {( {( K * S )}_{n} - {B}_{n} )}^{q} + ω {\sum }_{n} Φ ( {S}_{n} ) , where Φ ( {S}_{n} ) = {λ}_{1} \vert ∇ {S}_{n} \vert if \vert ∇ {S}_{n} \vert \leq T , = {λ}_{2} \vert ∇ {S}_{n} \vert + ( {λ}_{1} - {λ}_{2} ) T if \vert ∇ {S}_{n} \vert \geq T . \qquad Equation ( 10 )$$

When the noise is assumed to follow a Gaussian distribution, the power for the fidelity term(s) is equal to two (q=2).

In certain embodiments, as provided herein, a variable splitting technique can be used to minimize the cost function of Equation (10). For example, the variable splitting technique can include introducing one or more auxiliary variables, and one or more penalty terms into the latent sharp image estimation cost function to achieve a closed form solution because the power in the regularization tem is not equal to two. For example, the partial derivatives of the sharp image with respect to x and y can be replaced by auxiliary variables Zₓ and Z_{y}, and a penalty term is introduced to penalize the difference between each derivative and the corresponding auxiliary variable. This results in the following equation:

$$\tilde{c} ( S , {Z}_{x} , {Z}_{y} ) = {\sum }_{n} {( {( K * S )}_{n} - {B}_{n} )}^{2} + ω ( {\sum }_{n} Φ ( {( {( {Z}_{x} )}_{n}^{2} + {( {Z}_{y} )}_{n}^{2} )}^{\frac{1}{2}} ) + penalty ) . Where , penalty = β ( {\sum }_{n} {( {( {D}_{x} * S )}_{n} - {( {Z}_{x} )}_{n} )}^{2} + {\sum }_{n} {( {( {D}_{y} * S )}_{n} - {( {Z}_{y} )}_{n} )}^{2} ) . \qquad Equation ( 11 ) .$$

In Equation (11) and elsewhere, β is a penalty weight for the penalty.

The new latent sharp image cost function of Equation (11) can then be minimized iteratively, by alternating the minimization over S and over Zₓ and Z_{y}. Both these subproblems are relatively easy to solve as a closed form formula for the minimum exists for both of them.

Equation (11) can be minimized over S, by minimizing the following:

Σₙ((K*S)ₙ−Bₙ)²+ωβ(Σₙ((Dₓ*S)ₙ−(Zₓ)ₙ)²+Σₙ((D_{y}*S)ₙ−(Z_{y})ₙ)²). Equation (12).

This is somewhat similar to the deconvolution with Tikhonov-Miller regularization described above. The Fourier domain formula for the solution of Equation (12) is provided as follows:

$$S = {F}^{- 1} ( \frac{\overline{F ( K )} F ( B ) + ω β ( \overline{F ( {D}_{x} )} F ( {Z}_{x} ) + \overline{F ( {D}_{y} )} F ( {Z}_{y} ) )}{\overline{F ( K )} F ( K ) + ω β D} ) . \qquad Equation ( 13 )$$

As provided above, D=F̅(̅D̅ₓ̅)̅F(Dₓ)+F̅(̅D̅_̅{̅y̅}̅)̅F(D_{y}), and Dₓ and D_{y} are the convolution kernels that can be used to express the partial derivatives in x and y direction.

Equation (11) can be minimized over Zₓ and Z_{y}, by minimizing the following:

$${\sum }_{n} Φ ( {( {( {Z}_{x} )}_{n}^{2} + {( {Z}_{y} )}_{n}^{2} )}^{\frac{1}{2}} ) + β ( {\sum }_{n} {( {( {D}_{x} * S )}_{n} - {( {Z}_{x} )}_{n} )}^{2} + {\sum }_{n} {( {( {D}_{y} * S )}_{n} - {( {Z}_{y} )}_{n} )}^{2} ) . \qquad Equation ( 14 )$$

This can be done for every pixel “n” separately. The gradient of sharp image pixel at position n “Sₙ” can be denoted as follows:

|∇Sₙ|=\sqrt{(Dₓ*S)ₙ²+(D_{y}*S)ₙ²}. Equation (15)

Further, a generalized threshold function “Ψ” can be defined as follows:

$$\begin{matrix}ψ ( t ) = 0 , & if t \leq \frac{{λ}_{1}}{2 β} ,\end{matrix} \\ \begin{matrix}ψ ( t ) = t - \frac{{λ}_{1}}{2 β} , & if \end{matrix} \frac{{λ}_{1}}{2 β} < t \leq T + \frac{( {λ}_{1} + {λ}_{2} )}{4 β} , \\ \begin{matrix}ψ ( t ) = t - \frac{{λ}_{1}}{2 β} , & if\end{matrix} t > T + \frac{( {λ}_{1} + {λ}_{2} )}{4 β} . \qquad Equation ( 16 )$$

In Equation (16) and elsewhere, (i) the generalized threshold function “Ψ” is somewhat like a soft thresholding function, except the generalized threshold function (in this example) has two different thresholds that are determined by lamda 1 and lamda 2; and (ii) “t” is an independent variable that defines the function.

The solution to the minimization problem of Equation (14) can now be expressed as as follows:

$${Z}_{x} = \frac{ψ ( \vert ∇ {S}_{n} \vert )}{\vert ∇ {S}_{n} \vert} {( {D}_{x} * S )}_{n} , and {Z}_{y} = \frac{ψ ( \vert ∇ {S}_{n} \vert )}{\vert ∇ {S}_{n} \vert} {( {D}_{y} * S )}_{n} . \qquad Equation ( 17 )$$

The whole minimization process can be started by setting Zₓ=Z_{y}=0 at the beginning of the process. Next, the minimizations of Equations (13) and (17) can be repeated in the alternating fashion, with the penalty weight being increased in each iteration. This procedure is very similar to the variable splitting algorithm in the case of Laplacian regularization prior (p=1), in which case the generalized threshold function Ψ(t) is a soft thresholding function. In the present case, generalized threshold function Ψ(t) is only slightly more complicated.

The latent sharp image estimation cost function described above in Equation (10) can be modified in many different ways. For example, the variable splitting algorithm described above can be replaced another somewhat similar algorithm. For example, an algorithm, such as the one described in F. \check{S}roubek, P. Milanfar: Robust Multichannel Blind Deconvolution via Fast Alternating Minimization, IEEE Trans Im. Proc., 2012, (“\check{S}roubek”) can be used to minimize the latent sharp image cost function of Equation (10). As far as permitted, the contents of \check{S}roubek are incorporated herein by reference.

Alternatively or additionally, the latent sharp image estimation cost function of Equation (10) can be generalized to more than two dimensions and used, for example, for the deconvolution of three dimensional images, such as the three dimensional widefield image 314 (illustrated in FIG. 3A). In this case, the gradient involves also the partial derivative w.r.t. z and that there thus would be another auxiliary variable that replaces that derivative.

Alternatively or additionally, the latent sharp image estimation cost function of Equation (10) can be modified to add additional terms, and/or the fidelity terms of the latent sharp image cost function of Equation (10) can be modified. For instance, the latent sharp image cost function of Equation (10) can be modified to include fidelity terms that include image derivatives, resulting from applying a prior model to noise in image derivatives, such as the following:

Σₙ((K*Dₓ*S)ₙ−(Dₓ*B)ₙ)², Σₙ((K*D_{y}*S)ₙ−(D_{y}*B)ₙ)². Equation (18)

Alternatively or additionally, the fidelity term(s) of the the latent sharp image cost function can be modified to have a fidelity power of one (q=1) instead of a fidelity power of two (q=2). In this example, an absolute value is used for the fidelity power instead of a Gaussian value. This is (or would be) the result of using a Laplacian rather than Gaussian distribution as the noise model. In this embodiment, the fidelity term of Equation (10) can be replaced with the following fidelity term:

Σₙ|(K*S)ₙ−Bₙ|. Equation (19)

Additionally, or alternatively, the fidelity term(s) of the latent sharp image cost function can be modified to include one or more regularization weights “Wₙ”. In this embodiment, the fidelity term of Equation (10) can be replaced with the following fidelity term:

ΣₙWₙ((K*S)ₙ−Bₙ)². Equation (20)

As an example, the regularization weight(s) can help to approximate Poisson noise model by Gaussian noise model with image value dependent variance. One example of this process is described in more detail in E. F. Y. Hom, F. Marchais, T. K. Lee, S. Haase, D. A. Agard, J. W. Sedat: AIDA: an adaptive image deconvolution algorithm with application to multi-frame and three-dimensional data, J. Opt. Soc. Am. A, 24(6), 2007 (Hereinafter “Hom et al.”). As far as permitted, the contents of Hom et al. are incorporated herein by reference.

It should be noted that some of these modifications, like those provided in Equations (19) and (20), can be handled by also applying a variable splitting technique to the fidelity term(s). A non-exclusive example of the variable splitting technique being applied to the fidelity term(s) is provided in U.S. Pat. No. 9,245,328, entitled “ALGORITHM FOR MINIMIZING LATENT SHARP IMAGE COST FUNCTION AND POINT SPREAD FUNCTION COST FUNCTION WITH A SPATIAL MASK IN A FIDELITY TERM”, that issued on Jan. 26, 2016. As far as permitted, the contents of U.S. Pat. No. 9,245,328 are incorporated herein by reference. suitable (see NRCA PA1281).

Additionally or alternatively, the regularization terms of the latent sharp image estimation cost function can be modified. For example, in case of the fluorescence microscopy images, such as the Drosophila S2 cell image shown in FIG. 2A, not only is the image gradient sparse, but the image itself (pixel value) is also sparse. Thus, as provided herein, a similar multiple section, regularization power can also be used for the image itself.

An example of a modified latent sharp image cost function based on a multiple section, regularization term with a modified minimization process is a process that was developed for the deconvolution of three dimensional widefield microscope images. This modified latent sharp image estimation cost function can have the following form:

$$\begin{matrix}c ( S ) = {\sum }_{n} {{W}_{n} ( {( K * S )}_{n} - {B}_{n} )}^{2} + {ω}_{0} {\sum }_{n} {Φ}_{0} ( {S}_{n} ) + {ω}_{1} {\sum }_{n} {Φ}_{1} ( {S}_{n} ) , \\ where & Equation ( 21 ) \\ \begin{matrix}{Φ}_{1} ( {S}_{n} ) = {λ}_{1} \vert ∇ {S}_{n} \vert if \vert ∇ {S}_{n} \vert \leq {T}_{1} , \\ = {λ}_{2} \vert ∇ {S}_{n} \vert + ( {λ}_{1} - {λ}_{2} ) {T}_{1} if \vert ∇ {S}_{n} \vert \geq {T}_{1} ,\end{matrix} \\ and & Equation ( 22 ) \\ \begin{matrix} {Φ}_{0} ( {S}_{n} ) = {μ}_{1} \vert {S}_{n} \vert if \vert {S}_{n} \vert \leq {T}_{0} , \\ = {μ}_{2} \vert {S}_{n} \vert + ( {μ}_{1} - {μ}_{2} ) {T}_{0} if \vert {S}_{n} \vert \geq {T}_{0} . \end{matrix} & Equation ( 23 )\end{matrix}$$

In this example, Equation (22) involves the gradient magnitude, and Equation (23) involves the pixel magnitude (value). In Equations (22) and (23), and elsewhere, (i) lamda one (“λ₁”) is a slope of a linear, first gradient regularization function section; (ii) lamda two (“λ₂”) is a slope of a linear, second gradient regularization function section; (iii) mu one (“μ₁”) is a slope of a linear, first pixel value regularization function section; (iv) mu two (“μ₂”) is a slope of a linear, second pixel value regularization function section; (v) “T₁” is the location of the section knot in the gradient function and is greater than zero; (vi) “T₀” is the location of the section knot in the value function and is greater than zero; (vii) ω₀ is a value regularization weight; (viii) “ω₁” is is a gradient regularization weight; (ix) Φ₀ is a value regularization function; and (x) Φ₁ is a gradient regularization function. In this example, the slopes and/or the location of the section knots can be adjusted to change the characteristics of the latent sharp image estimation cost function.

In one embodiment, the latent sharp image estimation cost function of Equations (21)-(23) can be modified to include five auxiliary variables: (i) A replacing K*S, (ii) Z replacing S in the first regularization term, and (iii) Zₓ, Z_{y}, and Z_{z} replacing the derivatives of S with respect to x, y and z in the second regularization term (similarly to x- and y-derivatives in the previously described algorithm). The minimization of the iterative algorithm starts with setting all the auxiliary variables to 0 and then repeating the following steps:

$$\begin{matrix}S = {F}^{- 1} ( \frac{\begin{matrix}\overline{F ( K )} F ( B ) + ( {ω}_{0} β / α ) + ( {ω}_{1} β / α ) \\ ( \overline{F ( {D}_{x} )} F ( {Z}_{x} ) + \overline{F ( {D}_{y} )} F ( {Z}_{y} ) + \overline{F ( {D}_{x} )} F ( {Z}_{x} ) )\end{matrix}}{\overline{F ( K )} F ( K ) + ( {ω}_{0} β / α ) + ( {ω}_{1} β / α ) D} ) , \\ where & Equation ( 24 ) \\ D = \overline{F ( {D}_{x} )} F ( {D}_{x} ) + \overline{F ( {D}_{y} )} F ( {D}_{y} ) + \overline{F ( {D}_{z} )} F ( {D}_{z } ) , & Equation ( 25 ) \\ {A}_{n} = \frac{{W}_{n}}{{W}_{n} + α} {B}_{n} + \frac{α}{{W}_{n} + α} {( K * S )}_{n} , & Equation ( 26 ) \\ {Z}_{n} = {ψ}_{0} ( {S}_{n} ) , \\ where & Equation ( 27 ) \\ \begin{matrix}{ψ}_{0} ( t ) = 0 , & if t \leq \frac{{μ}_{1}}{2 β} ,\end{matrix} \\ \begin{matrix}{ψ}_{0} ( t ) = sign ( t ) ( \vert t ⌉ - \frac{{μ}_{1}}{2 β} ) , & if \end{matrix} \frac{{λ}_{1}}{2 β} < \vert t \vert \leq {T}_{0} + \frac{( {μ}_{1} + {μ}_{2} )}{4 β} , \\ and \\ \begin{matrix}{ψ}_{0} ( t ) = sign ( t ) ( \vert t \vert - \frac{{μ}_{2}}{2 β} ) , & if\end{matrix} t > {T}_{0} + \frac{( {μ}_{1} + {μ}_{2} )}{4 β} . & Equation ( 28 )\end{matrix}$$

### Further,

$$\begin{matrix} {Z}_{x} = \frac{ψ ( \vert ∇ {S}_{n} \vert )}{\vert ∇ {S}_{n} \vert} {( {D}_{x} * S )}_{n} , {Z}_{y} = \frac{ψ ( \vert ∇ {S}_{n} \vert )}{\vert ∇ {S}_{n} \vert} {( {D}_{y} * S )}_{n} , \\ {Z}_{z} = \frac{ψ ( \vert ∇ {S}_{n} \vert )}{\vert ∇ {S}_{n} \vert} {( {D}_{z} * S )}_{n} , \\ where & Equation ( 29 ) \\ \vert ∇ {S}_{n} \vert = \sqrt{{( {D}_{x} * S )}_{n}^{2} + {( {D}_{y} * S )}_{n}^{2} + {( {D}_{z} * S )}_{n}^{2}} , \\ and & Equation ( 30 ) \\ \begin{matrix} {ψ}_{1} ( t ) = 0 , & if t \leq \frac{{λ}_{1}}{2 β} ,\end{matrix} \\ \begin{matrix} {ψ}_{1} ( t ) = t - \frac{{λ}_{1}}{2 β} , & if \end{matrix} \frac{{λ}_{1}}{2 β} < t \leq {T}_{1} + \frac{( {λ}_{1} + {λ}_{2} )}{4 β} , \\ and \\ \begin{matrix}{ψ}_{1} ( t ) = t - \frac{{λ}_{1}}{2 β} , & if\end{matrix} t > {T}_{1} + \frac{( {λ}_{1} + {λ}_{2} )}{4 β} . & Equation ( 31 )\end{matrix}$$

During minimization, the penalty weights α and β are increased in each iteration. The minimization via variable splitting algorithm is very fast and typically requires only about 10 iterations to converge. This makes it very fast.

Other modifications to the latent sharp image estimation cost function are also possible. For example, the regularization function can be modified to include more than two linear sections.

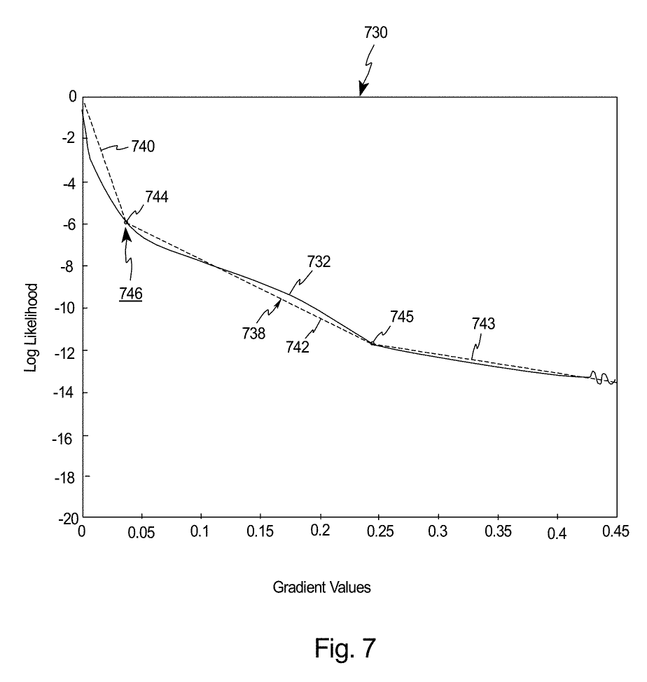

FIG. 7 is a graph 530 that illustrates log likelihood of gradient magnitude values for a hypothetical latent sharp image (not shown). More specifically, solid line 732 represents the gradient log likelihood prior distribution for the hypothetical latent sharp image. Further, the dashed line 738 in FIG. 7 represents the gradient log likelihood prior distribution for yet embodiment of the multiple section, regularization term provided herein. Importantly, the multiple section, regularization term (represent by line 738) can be adjusted and tailed to closely correspond to the gradient magnitude values 732 of the hypothetical latent sharp image.

In this embodiment, the regularization function 738 includes (i) a linear first section 740 having a first slope, (ii) a linear second section 742 having a second slope that is different from the first slope, (iii) a first section knot 744 (highlighted with a circle) that joints the first section 740 to the second section 742, (iv) a linear third section 743 having a third slope that is different from the first slope and the second slope, and (v) a second section knot 745 (highlighted with a circle) that joints the second section 742 to the third section 743 to form a continuous multiple section, regularization function 738. Alternatively, the multiple section, regularization function 738 can be designed to include more than three linear sections, which will result in at least three section knots.

As provided herein, the number of linear section(s), the slope of each linear section, and the location of each section knot can be collectively referred to as “regularization parameters” 746 of the regularization function 738. Further, the regularization parameters can be adjusted to tune the regularization function 738 for different distributions of gradients.

As provided herein, the advantage of the present, proposed approach is that it is nearly as simple as the analogous algorithm with the Laplacian prior, but it allows modeling the properties of the image much more accurately. On top of that, the same algorithm can be easily adapted to images with different distributions of gradients. It requires merely changing the regularization parameters 546 of the multiple section regularization function, and consequently, the parameters of the generalized threshold function Ψ (see equations (17) , (28), and (31). Importantly, the algorithm and the minimization remains to be the same. Thus, the same variable splitting algoritm can be used to minimize the latent sharp image estimation cost function, irregardless of the adjustments to the regularization parameters 546.

In yet another embodiment, instead of a latent sharp image estimation cost function, the proposed multiple section regularization term can be used in a point spread function estimation cost function. In this embodiment, the multiple section regularization term can be used as the prior for the distribution of PSF values or the values, the partial derivatives of the PSF, or of the PSF gradient magnitude. In one embodiment, the resulting algorithm would be very similar to that described above for image deconvolution, except the roles of the latent sharp image S and the PSF kernel K would be swapped in all the equations. For example. Equation (10) can be rewritten as a PSF estimation cost function “c(K)” as follows:

$$c ( K ) = {\sum }_{n} {( {( S * K )}_{n} - {B}_{n} )}^{q} + ω {\sum }_{n} Φ ( {K}_{n} ) , \\ \begin{matrix}Φ ( {K}_{n} ) = {λ}_{1} \vert ∇ {K}_{n} \vert if \vert ∇ {K}_{n} \vert \leq T , \\ = {λ}_{2} \vert ∇ {K}_{n} \vert + ( {λ}_{1} - {λ}_{2} ) T if \vert ∇ {K}_{n} \vert \geq T .\end{matrix} \qquad Equation ( 32 )$$

It should be noted that Equation (32) can be solved using a variable splitting technique similar to the latent sharp image estimation cost function described above. Further, the fidelity term(s) and/or regularization term(s) of the PSF estimation cost function can be modified in a similar fashion as described above in reference to the latent sharp image estimation cost function.

While the current invention is disclosed in detail herein, it is to be understood that it is merely illustrative of the presently preferred embodiments of the invention and that no limitations are intended to the details of construction or design herein shown other than as described in the appended claims.

What is claimed is:

1. A method for estimating a latent sharp image for at least a portion of a blurry image that includes a plurality of pixels, the method comprising:
estimating the latent sharp image for at least a portion of the blurry image with a control system that includes a processor, the control system utilizing a latent sharp image estimation cost function having a regularization term that has a linear first section and a linear second section to characterize the plurality of pixels and adjust at least some of the pixels to provide the estimated latent sharp image, wherein the first section has a first slope and the second section has a second slope that is different from the first slope.

2. The method of claim 1 wherein the step of estimating includes the first section being connected to the second section at a section knot.

3. The method of claim 2 wherein the step of estimating a latent sharp image includes the latent sharp image estimation cost function including the following regularization term:
ΣₙΦ(Sₙ),
where (i) “Φ” is a regularization function that depends on the prior model used to express the expected properties of the sharp image; (ii) “Sₙ” is the sharp image pixel as position n; (iii) Φ(Sₙ)=λ₁|∇Sₙ| if |∇Sₙ|≦T; (iv) Φ(Sₙ)=λ₂|∇Sₙ|+(λ₁−λ₂)T if |∇Sₙ|≧T; (v) “λ₁” is the slope of the first section; (vi) “λ₂” is the slope of the second section; and (vii) “T” is the location of the section knot.

4. The method of claim 2 wherein the step of estimating a latent sharp image includes the latent sharp image estimation cost function including the following fidelity term:
Σₙ((K*S)ₙ−Bₙ)^{q},
where (i) K is the point spread function kernel; (ii) S is the latent sharp image; (iii) B is the blurry image; (iv) n is the position of the pixel; and (v) q is a fidelity power.

5. The method of claim 2 wherein the step of estimating includes adjusting at least one of (i) the first slope, (ii) the second slope, and (iii) the location of the section knot to adjust the estimation of the latent sharp image.

6. The method of claim 2 wherein the step of estimating includes adjusting at least two of (i) the first slope, (ii) the second slope, and (iii) the location of the section knot to adjust the estimation of the latent sharp image.

7. The method of claim 1 further comprising the step of utilizing a variable splitting technique with the control system to minimize the latent sharp image estimation cost function.

8. The method of claim 1 wherein the step of estimating includes the regularization power having a linear third section having a third slope that is different from the first slope and the second slope.

9. The method of claim 8 wherein the step of estimating includes the first section being connected to the second section at a first section knot, and the second section being connected to the third section at a second section knot.

10. A system for estimating a latent sharp image for at least a portion of a blurry image that includes a plurality of pixels, the system comprising:
a control system that estimates the latent sharp image utilizing a latent sharp image estimation cost function having a regularization term that has a linear first section and a linear second section to characterize the plurality of pixels and adjust at least some of the pixels to provide the estimated latent sharp image, wherein the first section has a first slope and the second section has a second slope that is different from the first slope.

11. The system of claim 10 wherein the first section is connected to the second section at a section knot.

12. The system of claim 11 wherein the latent sharp image estimation cost function including the following regularization term:
ΣₙΦ(Sₙ),
where (i) “Φ” is a regularization function that depends on the prior model used to express the expected properties of the sharp image; (ii) “Sₙ” is the sharp image pixel as position n; (iii) Φ(Sₙ)=λ₁|∇Sₙ| if |∇Sₙ|≦T; (iv) Φ(Sₙ)=λ₂|∇Sₙ|+(λ₁−λ₂T if |∇Sₙ|≧T; (v) “λ₁” is the slope of the first section; (vi) “λ₂” is the slope of the second section; and (vii) “T” is the location of the section knot.

13. The system of claim 11 wherein the latent sharp image estimation cost function including the following fidelity term:
Σₙ((K*S)ₙ−Bₙ)^{q},
where (i) K is the point spread function kernel; (ii) S is the latent sharp image; (iii) B is the blurry image; (iv) n is the position of the pixel; and (v) q is a fidelity power.

14. The system of claim 11 wherein the control system adjusts at least one of (i) the first slope, (ii) the second slope, and (iii) the location of the section knot to adjust the estimation of the latent sharp image.

15. The system of claim 11 wherein the control system adjusts at least two of (i) the first slope, (ii) the second slope, and (iii) the location of the section knot to adjust the estimation of the latent sharp image.

16. The system of claim 10 wherein the control system utilizes a variable splitting technique to minimize the latent sharp image estimation cost function.

17. The system of claim 10 wherein the regularization term includes a linear third section having a third slope that is different from the first slope and the second slope.

18. The system of claim 17 wherein the first section is connected to the second section at a first section knot, and the second section is connected to the third section at a second section knot.

19. A method for estimating a point spread function for at least a portion of a blurry image that includes a plurality of pixels, the method comprising:
estimating the point spread function with a control system that includes a processor, the control system utilizing a point spread function estimation cost function having a regularization term that has a linear first section and a linear second section to characterize the plurality of pixels and adjust at least some of the pixels to provide the estimated latent sharp image, wherein the first section has a first slope and the second section has a second slope that is different from the first slope.

20. The method of claim 19 wherein the step of estimating includes the first section being connected to the second section at a section knot.
